(19) United States
(12) Patent Application Publication
(10) Pub. No.: US 2006/0170352 A1
(43) Pub. Date: Aug. 3, 2006

(54) Plasma display panel

(76) Inventors: Eun-Young Jung, Suwon-si (KR); Kyoung-Doo Kang, Suwon-si (KR)

Correspondence Address: Robert E. Bushnell, Suite 300, 1522 K Street, N.W., Washington, DC, 20005-1202, US

(21) Appl. No.: 11/333,322

(22) Filed: Jan. 18, 2006

(30) Foreign Application Priority Data
Feb. 1, 2005 (KR) 10-2005-0009095

(51) Int. Cl. H01J 17/49

(52) U.S. Cl. 313/582; 313/587; 313/586

(57) ABSTRACT

A plasma display panel comprises: a first substrate which includes first partition wall portions defining a plurality of discharge cells; a second substrate which faces the first substrate, and includes second partition wall portions defining the discharge cells together with the first partition wall portions; a plurality of pairs of first and second discharge electrodes which generate discharge in the discharge cells; a dielectric layer interposed between the first substrate and the second substrate; phosphor layers located in the discharge cells; and discharge gas located in the discharge cells.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on 1 Feb. 2005 and there duly assigned Serial No. 10-2005-0009095.

### BACKGROUND OF THE INVENTION

1. Technical Field

The present invention relates to a plasma display panel having a new structure.

2. Related Art

A plasma display panel has excellent characteristics, such as large area, high quality, slimness, light weight, and wide viewing angle, and is more easily manufactured and enlarged than other flat panel display devices. Thus, the plasma display panels are now attracting much attention as the next generation of large-area flat display panels.

In a three-electrode surface discharge plasma display panel, luminous efficiency is low because visible light rays emitted from a phosphor layer are mostly absorbed (about 40%) by sustain electrodes arranged on the lower surface of a first substrate, a first dielectric layer covering the sustain electrodes and an MgO layer.

Furthermore, when the three-electrode surface discharge plasma display panel displays the same image for a long time, the phosphor layer sputters ions due to charged particles of discharge gas so as to form permanent image sticking.

Also, once address electrodes and a second dielectric layer are formed on a second substrate, and a partition wall is separately formed on the second dielectric layer, the manufacturing process is complicated.

### SUMMARY OF THE INVENTION

The present invention provides a plasma display panel having a new structure.

According to an aspect of the present invention, a plasma display panel comprises: a first substrate which includes first partition wall portions defining a plurality of discharge cells; a second substrate which faces the first substrate and includes second partition wall portions defining the discharge cells together with the first partition wall portions; a plurality of pairs of first and second discharge electrodes which generate discharge in the discharge cells; a dielectric layer which is interposed between the first substrate and the second substrate; phosphor layers which are located in the discharge cells; and discharge gas which is located in the discharge cells.

In the exemplary embodiment, the first discharge electrodes may be located in the first partition wall portions and extend so as to surround the discharge cells arranged in a direction, and the second discharge electrodes may be located in the second partition wall portions and extend so as to surround the discharge cells arranged in a direction.

Furthermore, the dielectric layer may be interposed between the first partition wall portions and the second partition wall portions.

The plasma display panel according to the present invention has the following effects.

First, since the partition wall and the substrate are integrally formed, the strength of the partition wall increases.

Second, when the plasma display panel is manufactured, the processes of manufacturing an upper substrate and a lower substrate are similar to each other, and are simple. Accordingly, the total manufacturing cost is reduced.

Third, since surface discharge can be generated in all sides of the discharge space, the discharge surface can be enlarged.

Fourth, since the discharge is generated in the side forming the discharge cell and spreads into the center of the discharge cell, the discharge area is wider than in the general plasma display panel, and thus the discharge cell can be efficiently used. Accordingly, a low driving voltage can be used, and thus luminous efficiency can be greatly improved.

Fifth, since low voltage driving is possible, even when a high-concentration Xe discharge gas is used, the luminous efficiency can be improved.

Sixth, discharge response speed is high and low voltage driving is possible. The discharge electrode is located on the side of the discharge space, not on the first and second substrates which transmit visible light. Accordingly, a transparent discharge electrode having a high resistance need not be used. Thus, since a discharge electrode having a low resistance, such as a metal electrode, can be used, the discharge response speed is high, and low voltage driving is possible without distortion of a waveform.

Seventh, permanent image sticking can be fundamentally prevented. Since the electric field generated by a voltage which is applied to the discharge electrode formed on the side of the discharge space concentrates plasma in the center of the discharge space, the electric field prevents ions generated by the discharge from colliding with the phosphor layer, which prevents damage to the phosphor layer by ion sputtering, and thus no permanent image sticking forms. Conventionally, the permanent image sticking is more serious when high-concentration Xe discharge gas is used, but in the present invention, the permanent image sticking can be fundamentally prevented.

Eighth, when the dielectric layer contains a light absorption material, external light reflection is reduced. Accordingly, contrast is improved.

### BRIEF DESCRIPTION OF THE DRAWINGS

A more complete appreciation of the invention and many of the attendant advantages thereof will be readily apparent as the same becomes better understood by reference to the following detailed description when considered in conjunction with the accompanying drawings in which like reference symbols indicate the same or similar components, wherein:

FIG. 1 is a perspective view of a plasma display panel;

FIG. 2 is a partial perspective view of a plasma display panel according to a first embodiment of the present invention;

FIG. 3 is a cross-sectional view taken along line III-III of FIG. 2;

FIG. 4 is a layout diagram of discharge cells and electrodes shown in FIG. 2;

FIG. 5 is a partial perspective view of a plasma display panel according to a second embodiment of the present invention;

FIG. 6 is a cross-sectional view taken along line VI-VI of FIG. 5; and

FIG. 7 is a layout diagram of discharge cells and electrodes shown in FIG. 5.

### DETAILED DESCRIPTION OF THE INVENTION

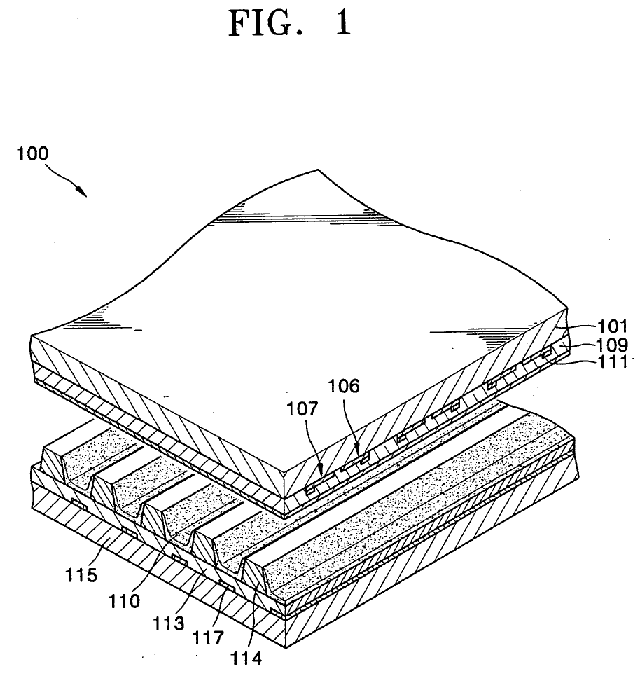

FIG. 1 is a perspective view of a plasma display panel, and more particularly a three-electrode, surface discharge plasma display panel.

In the plasma display panel 100 of FIG. 1, luminous efficiency is low because visible light rays emitted from a phosphor layer 110 are mostly absorbed (about 40%) by sustain electrodes 106 and 107 arranged on the lower surface of a first substrate 101, a first dielectric layer 109 covering the sustain electrodes 106 and 107, and an MgO layer 111.

Furthermore, when the three-electrode surface discharge plasma display panel 100 displays the same image for a long time, the phosphor layer 110 sputters ions due to charged particles of discharge gas so as to form permanent image sticking.

Also, since address electrodes 117 and a second dielectric layer 113 are formed on a second substrate 115, and a partition wall 114 is separately formed on the second dielectric layer 113, the manufacturing process is complicated.

### First Embodiment

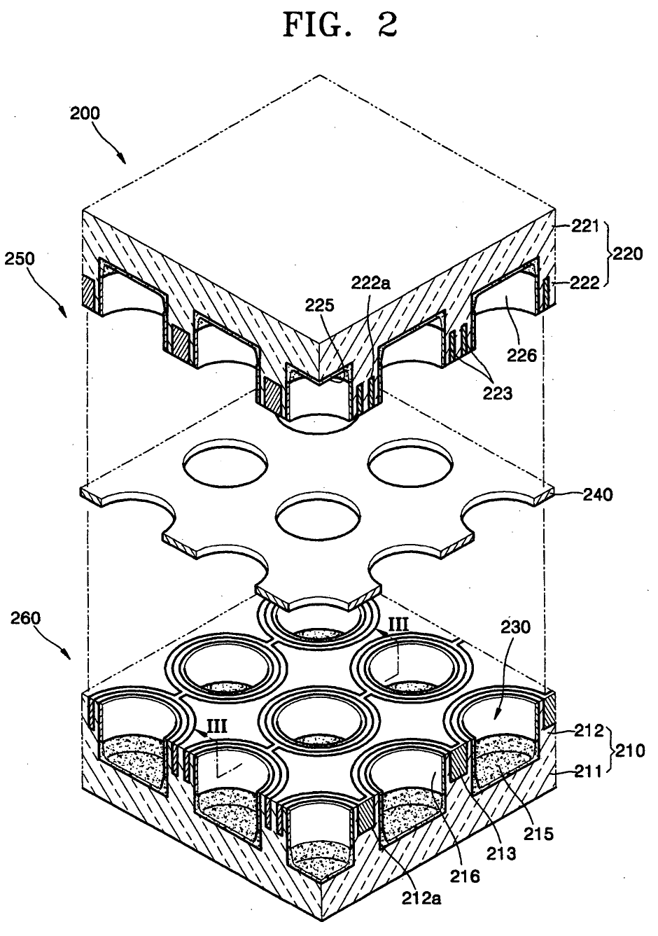

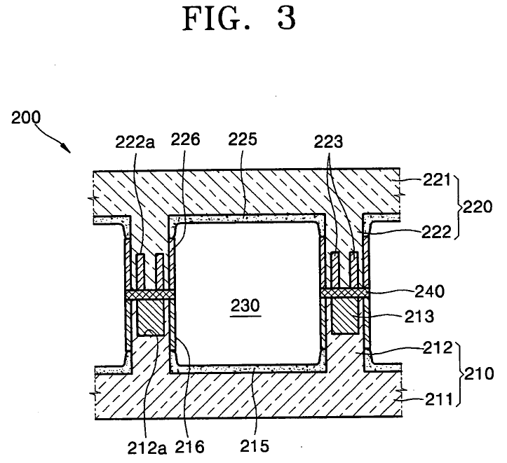

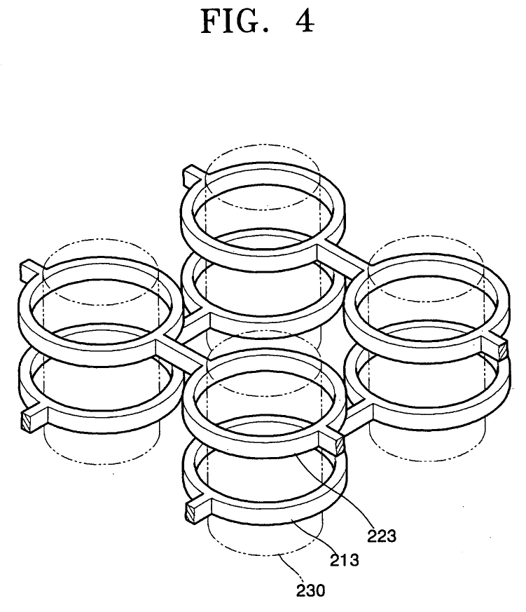

FIG. 2 is a partial perspective view of a plasma display panel according to a first embodiment of the present invention; FIG. 3 is a cross-sectional view taken along line III-III of FIG. 2; and FIG. 4 is a layout diagram of discharge cells and electrodes shown in FIG. 2.

A plasma display panel 200 according to a first embodiment of the present invention will now be described in detail with reference to FIGS. 2 thru 4.

The plasma display panel 200 includes a first substrate 210, a second substrate 220, first discharge electrodes 213, second discharge electrodes 223, first protective layers 216, second protective layers 226, first phosphor layers 215, second phosphor layers 225, a dielectric layer 240, and discharge gas (not shown).

The first substrate 210 is generally made of a material which mainly includes glass, and which has excellent light transmission. Also, the second substrate 220 is parallel to and spaced apart from the first substrate 210, and is also generally made of a material which mainly includes glass, and which has excellent light transmission.

In the present embodiment, visible light rays generated in the discharge cells 230 can be emitted to the outside through the first substrate 210 and/or the second substrate 220. The sustain electrodes 106 and 107, the first dielectric layer 109, and the protective layer 111, which exist on the first substrate 101 of the plasma display panel of FIG. 1, do not exist on the first substrate 210 and/or the second substrate 220 of FIG. 2 through which the visible light rays penetrate, and thus the transmission of the visible light rays can be greatly improved. When an image is displayed at a brightness similar to that of a conventional plasma display panel, the first and second discharge electrodes 213 and 223 can be driven at a relatively low voltage, and thus luminous efficiency can be improved.

The first substrate 210 includes a first substrate portion 211 and first partition wall portions 212. The first substrate portion 211 has a flat shape and is made of glass. The first partition wall portions 212 are arranged on the first substrate portion 211 facing the second substrate 220. The first partition wall portions 212 and the first substrate portion 211 are integrally formed. In FIG. 2, the first partition wall portions 212 define the discharge cells 230 having circular cross-sections. However, the present invention is not limited to this, and various patterns may be used, as long as a plurality of discharge spaces can be formed. For example, the cross-section of each discharge cell 230 may be triangular, rectangular, pentagonal, hexagonal, or elliptical.

The second substrate 220 includes a second substrate portion 221 and second partition wall portions 222. The second substrate portion 221 has a flat shape and is made of glass. The second partition wall portions 222 are arranged on the second substrate portion 221 facing the first substrate 210. The second partition wall portions 222 and the second substrate portion 221 are integrally formed. In FIG. 2, the second partition wall portions 222 define the discharge cells 230 having circular cross-sections. However, the present invention is not limited to this, and various patterns may be used, as long as a plurality of discharge spaces can be formed. For example, the cross section of each discharge cell 230 may be triangular, rectangular, pentagonal, hexagonal, or elliptical. Also, the first partition wall portions 212 and the second partition wall portions 222 may have different shapes, but are preferably of the same shape, for discharge uniformity and manufacturing convenience.

In FIG. 4, the first discharge electrodes 213 are shown. The first discharge electrode 213 and the second discharge electrode 214 form a pair so as to generate discharge in the discharge cell 230. Each of the first discharge electrodes 213 has a shape in which a plurality of circular loops are connected to one another, and is located in the first partition wall portions 212. The first discharge electrodes 213 extend so as to surround the discharge cells 230 arranged in a direction. That is, circular loop-shaped first grooves 212a, extending so as to surround the discharge cells 230, are formed to a predetermined depth in the first partition wall portion 212 facing the second partition wall portions 222. The first discharge electrodes 213 are located in the first grooves 212a. The first grooves 212a may be formed using various methods, such as sandblasting or photo etching.

Furthermore, in FIG. 4, the second discharge electrodes 223 are shown. The second discharge electrodes 223 extend in a direction crossing the first discharge electrodes 213, and are located in the second partition wall portions 222. Each of the second discharge electrodes 223 has a shape in which a plurality of circular loops are connected to one another, similar to the first discharge electrodes 213. That is, circular loop-shaped second grooves 222a extending to surround the discharge cells 230 are formed in the second partition wall portion 222, and the second discharge electrodes 223 are located in the second grooves 222a. To ensure uniform discharge in the discharge cells 230, it is preferable that the ring shapes of the first discharge electrode 213 and the second discharge electrode 223 be symmetrical to each other. The second grooves 222a may also be formed using various methods, such as sandblasting or photo etching.

The plasma display panel 200 according to this embodiment has a two-electrode structure. Accordingly, either one of the first discharge electrode 213 and the second discharge electrode 223 can serve as a scan and sustain electrode, and the other can serve as an address and sustain electrode.

Since the first discharge electrodes 213 and the second discharge electrodes 223 are not located in the path of visible light, they may be formed of conductive metal, such as aluminum or copper. This ensures a low voltage drop and stable signal transmission.

Referring to FIGS. 2 and 3, the dielectric layer 240 is interposed between the first partition wall portions 212 and the second partition wall portion 222 so as to resist the dielectric breakdown voltage between the first discharge electrodes 213 and the second discharge electrodes 223. In the present embodiment, the dielectric layer 240 contains a light absorption material for preventing external light from being reflected in the plasma display panel 200 and re-emitted as unwanted glare. Since the dielectric layer 240 reduces the reflection of external light, contrast increases. Also, the dielectric layer 240 is located between the first partition wall portions 212 and the second partition wall portion 222, in which the discharge is not directly generated. Accordingly, the dielectric layer 240 absorbs unnecessary visible light generated in the discharge cells 230, so that deterioration of brightness is minimized. The dielectric layer 240 may be formed of various materials containing light absorption material, and is preferably a colored material having a light absorption ratio of 50% to 100%. The dielectric layer 240 may be formed by mixing a dark colored pigment with a transparent dielectric material such as PBO, B₂O₃, or SiO₂.

It is preferable that portions of the sides of the first partition wall portions 212 adjacent to the first discharge electrodes 213 be covered by the MgO layers 216 as the first protective layer 216. It is also preferable that portions of the sides of the second partition wall portions 222 adjacent to the second discharge electrodes 223 be covered by the MgO layers 216 as the second protective layers 226. The MgO layers 216 and 226 are not absolutely necessary, but they do prevent the first partition wall portions 212 and the second partition wall portions 222 from being damaged by charged particles, and emit many secondary electrons during the discharge.

Referring to FIGS. 2 and 3, the first phosphor layers 215 are coated on the sides of the first partition wall portions 212 and the first substrate portion 211 located between the first partition wall portions 212. Particularly, the first phosphor layers 215 coated on the sides of the first partition wall portions 212 are located between the first protective layers 216 and the first substrate portion 211. Also, the second phosphor layers 225 are coated on the sides of the second partition wall portions 222 and the second substrate portion 221 located between the second partition wall portions 222. Similar to the first phosphor layers 215, the second phosphor layers 225 coated on the sides of the second partition wall portions 222 are located between the second protective layers 226 and the second substrate portion 221.

The first and second phosphor layers 215 and 225, respectively, have components for receiving ultraviolet rays and generating visible light rays. The phosphor layer formed in a red discharge cell contains a phosphor such as Y(V,P)O₄:Eu, the phosphor layer formed in a green discharge cell contains a phosphor such as Zn₂SiO₄:Mn, YBO₃:Tb, and the phosphor layer formed in a blue discharge cell contains a phosphor such as BAM:Eu.

Discharge gas, such as Ne, Xe or a mixture thereof, is deposited in the discharge cells 230. In the present embodiment, since the discharge surface increases and the discharge region can be enlarged, the amount of plasma increases, and thus a low driving voltage can be realized. Accordingly, even when high-concentration Xe gas is used as the discharge gas, low voltage driving can be realized, and thus the luminous efficiency can be greatly improved. Therefore, the problem of high-concentration Xe gas requiring an excessively high driving voltage is solved.

Hereinafter, a method of manufacturing the plasma display panel 200 will be described in detail.

It is preferable that the plasma display panel 200 be manufactured by separately manufacturing an upper substrate 250 and a lower substrate 260, and by combining the substrates 250 and 260 using a sealing member, such as frit glass.

First, a method of manufacturing the upper substrate 250 will be described. A mask for forming the second partition wall portion 222 is disposed above a sheet of glass, and the glass is sandblasted or etched, thereby forming the second substrate 220, including the second partition wall portions 222 and the second substrate portion 221. Thereafter, the second substrate 220 is sandblasted using a mask having patterns substantially equal to the shapes of the second discharge electrodes 223 so as to form the second grooves 222a to house the second discharge electrodes 223. The second grooves 222a may be formed using other methods, such as etching. Next, an electrode material is printed in the second grooves 222a, and is then heated and dried to form the second discharge electrodes 223. Subsequently, a dielectric material is coated on the second partition wall portions 222 so as to bury the second discharge electrodes 223, and is then heated and dried to form the dielectric layer 240. Alternatively, the dielectric layer 240 may be formed on the first partition wall portions 212 so as to bury the first discharge electrodes 213 located in the first grooves 212a, or the dielectric layer 240 may be formed on both the first partition wall portions 212 and the second partition wall portions 222. Next, the second phosphor layers 225 are formed on the second substrate 220 by pattern printing or photosensitive printing, and then the second protective layers 226 are formed by deposition.

A method of manufacturing the lower substrate 250, including the first substrate 210, the first discharge electrodes 213, the first phosphor layers 215 and the first protective layers 216, is similar to the method of manufacturing the upper substrate 260, and thus its description will not be repeated.

According to the plasma display panel 200 of this first embodiment of the present invention, the processes of manufacturing the upper substrate 250 and the lower substrate 260 are simple, and are similar to each other. Thus, the process efficiency is improved and manufacturing costs are reduced.

In the plasma display panel 200 according to the first embodiment of the present invention, address discharge is generated between the first discharge electrode 213 and the second discharge electrode 223 so as to select the discharge cells 230 in which sustain discharge will be generated. Thereinafter, when an alternating current (AC) sustain discharge voltage is applied between the first discharge electrodes 213 and the second discharge electrodes 223 of the selected discharge cell 230, the sustain discharge is generated between the first discharge electrode 213 and the second discharge electrode 223. The energy level of the discharge gas is excited by the sustain discharge drops, and thus ultraviolet rays are emitted. The ultraviolet rays excite the first and second phosphor layers 215 and 225, respectively, coated in the discharge cell 230. Accordingly, when the energy levels of the excited first and second phosphor layers 215 and 225, respectively, drop, visible light is emitted. The emitted visible light forms an image on the display panel 200.

In the plasma display panel 100 of FIG. 1, the sustain discharge between the sustain electrodes 106 and 107 is generated horizontally, and thus the discharge area is relatively small. However, the sustain discharge of the plasma display panel 200 according to the first embodiment of the present invention is generated at all sides of the discharge cell 230, and the discharge area is relatively large.

In the first embodiment of the invention, the sustain discharge is formed in a closed curve along the sides of the discharge cell 230, and gradually spreads to the center of the discharge cell 230. Accordingly, the sustain discharge is generated in a larger area, and space charges in the discharge cell, which were not used in prior arrangements, contribute to the light emission. Thus, the luminous efficiency of the plasma display panel is improved. In particular, in the present invention, since the cross-sections of the discharge cells 230 are circular, the sustain discharge is generated uniformly in all sides of the discharge cells 230.

Furthermore, since the sustain discharge is generated at the center of the discharge cell 230, the phosphor layer is prevented from sputtering ions by the charged particles, and thus no permanent image sticking forms, even when an image is displayed for a long time.

### Second Embodiment

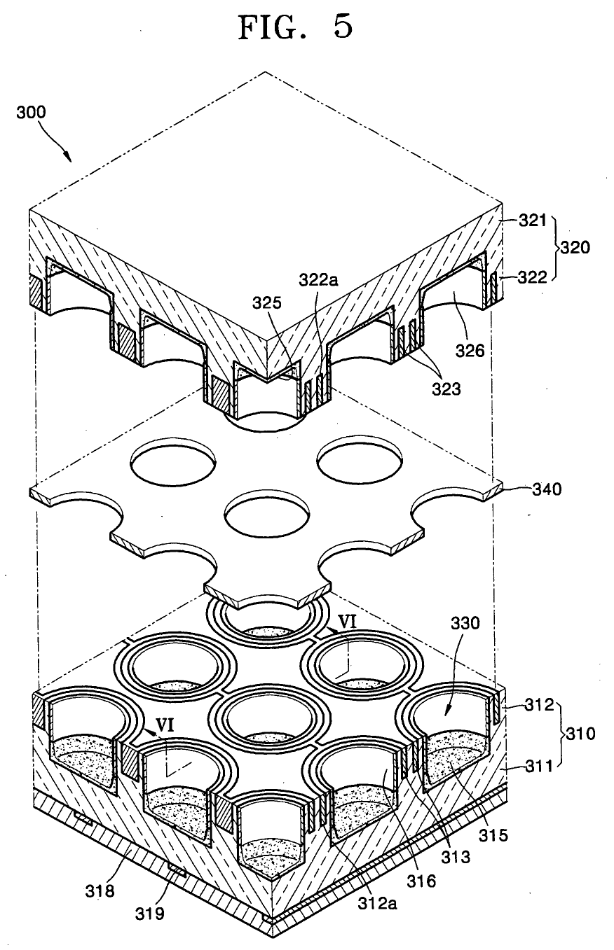

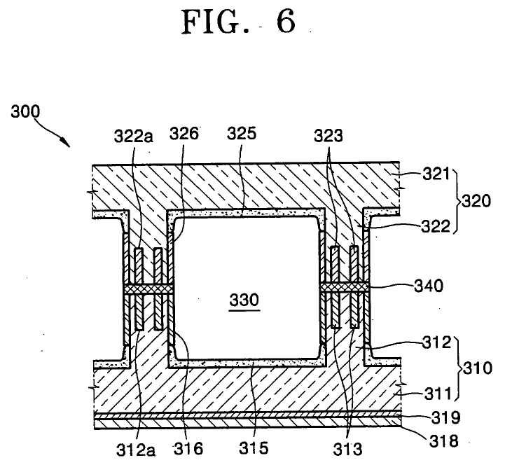

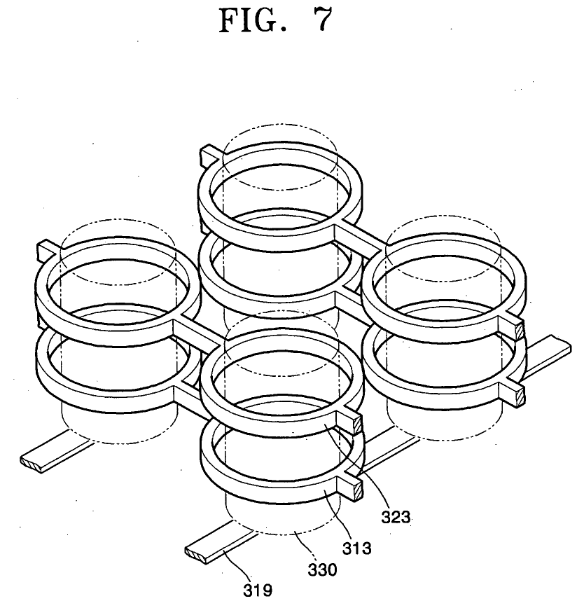

FIG. 5 is a partial perspective view of a plasma display panel according to a second embodiment of the present invention; FIG. 6 is a cross-sectional view taken along line VI-VI of FIG. 5; and FIG. 7 is a layout diagram of discharge cells and electrodes shown in FIG. 5.

A plasma display panel according to a second embodiment of the present invention will now be described with reference to FIGS. 5 thru 7.

The plasma display panel 300 according to the second embodiment of the invention includes a first substrate 310, first discharge electrodes 313, first protective layers 316, first phosphor layers 315, address electrodes 319, a dielectric layer 318, a second substrate 320, second discharge electrodes 323, a dielectric layer 340, second protective layers 326, second phosphor layers 325, and discharge gas (not shown).

The first substrate 310 and the second substrate 320 are parallel to, and spaced apart from, each other, and are made of a material containing glass so as to improve the visible light transmissivity.

The first substrate 310 includes a first substrate portion 311 and first partition wall portions 312. The first substrate portion 311 has a flat shape, and is made of glass. The first partition wall portions 312 are arranged on the first substrate portion 311 facing the second substrate 320. The first partition wall portions 312 and the first substrate portion 311 are integrally formed.

The second substrate 320 includes a second substrate portion 321 and second partition wall portions 322. The second substrate portion 321 has a flat shape, and is made of glass. The second partition wall portions 322 are arranged on the second substrate portion 321 facing the first substrate 310. The second partition wall portions 322 and the second substrate portion 321 are integrally formed.

In a manner similar to the first embodiment, the first partition wall portions 312 and the second partition wall portions 322 may have various shapes, and define the discharge cells 330 having circular cross-sections. The first partition wall portions 312 and the second partition wall portions 322 may have different shapes, but they preferably have the same shape.

Referring to FIG. 7, each of the first discharge electrodes 313 and the second discharge electrodes 323 has the shape of a line which surrounds a line of discharge cells 330. Also, the first discharge electrode 313 and the second discharge electrode 314 form a pair, and generate discharge in the discharge cell 330. Unlike the first embodiment, the first discharge electrode 313 and the second discharge electrode 323 extend in parallel with each other.

Each of the first discharge electrodes 313 has a shape in which a plurality of circular loops are connected to one another, and is located in the first partition wall portions 312. To be more specific, first grooves 312a are formed to a predetermined depth in the first partition wall portions 312 along the discharge cells 330, and are connected to one another, and the first discharge electrodes 313 are located in the first grooves 312a.

Each of the second discharge electrodes 323 has a shape in which a plurality of circular loops are connected to one another, similar to the first discharge electrodes 313. To be more specific, second grooves 322a are formed to a predetermined depth in the second partition wall portions 322 along the discharge cells 330, and are connected to one another, and the second discharge electrodes 323 are located in the second grooves 322a.

The materials of the first discharge electrodes 313 and the second discharge electrodes 323 are similar to those of the first discharge electrodes 213 and the second discharge electrodes 223 of the first embodiment, and thus their description will not be repeated.

Referring to FIGS. 5 and 6, the dielectric layer 340 is interposed between the first partition wall portions 312 and the second partition wall portions 322. The dielectric layer 340 is formed so as to resist the dielectric breakdown voltage between the first discharge electrodes 313 and the second discharge electrodes 323, and dielectric layer 340 is preferably made of PbO, B₂O₃, or SiO₂.

The address electrodes 319 which cross the discharge cells 330 are arranged on the opposite surface of the first substrate portion 311 facing the second substrate 320. The address electrodes 319 extend so as to cross a direction in which the first discharge electrodes 313 and the second discharge electrodes 323 extend. The address electrodes are not limited to this arrangement, and may be positioned at various locations, including the opposite surface of the second substrate portion 321 facing the first substrate 310.

The address electrodes 319 generate address discharge so as to encourage sustain discharge between the first discharge electrode 313 and the second discharge electrode 323, and more particularly, lower the voltage for initiating the sustain discharge. The address discharge is generated between the scan electrode and the address electrode. When the address discharge is finished, positive ions are accumulated in the scan electrode, and electrons are accumulated in a common electrode, so as to further aid the sustain discharge between the scan electrode and the common electrode.

If the interval between the scan electrode and the address electrode is narrow, the address discharge is efficiently generated. Accordingly, in the present embodiment, it is preferable that the first discharge electrode 313 adjacent to the address electrode 319 serve as the scan electrode, and that the second discharge electrode 323 serve as the common electrode.

It is preferable that the address electrode 319 be buried by the dielectric layer 318. The dielectric layer 318 may be locally formed so as to bury only the address electrodes 319, and may be coated on the first substrate portion 311. The dielectric layer 318 prevents the address electrode 319 from being damaged, and may be made of PbO, B₂O₃, or SiO₂.

The structure, operation and materials of the first phosphor layers 315 located on the first substrate 311 and the side of the first partition wall portion 312, and the second phosphor layers 325 located on the second substrate 321 and the side of the second partition wall portion 322, are similar to those of the first and second phosphor layers 215 and 225, respectively, of the first embodiment, and thus their description will not be repeated.

Moreover, the structure, operation and materials of the first and second protective layers 316 and 326, respectively, located on the side of the first partition wall portion 312 and the side of the second partition wall portion 322, respectively, are similar to those of the first and second protective layers 216 and 226, respectively, of the first embodiment, and thus their description will not be repeated.

In the plasma display panel 300 according to the second embodiment of the present invention having the aforementioned structure, the address voltage is applied between the address electrode 319 and the first discharge electrode 313 so as to generate the address discharge, and so as to select the discharge cells 330 in which the sustain discharge will be generated.

Thereafter, when an AC sustain discharge voltage is applied between the first discharge electrode 313 and the second discharge electrode 323 of the selected discharge cell 330, the sustain discharge is generated between the first discharge electrode 313 and the second discharge electrode 323. The energy level of the discharge gas excited by the sustain discharge drops, and thus ultraviolet rays are emitted. The ultraviolet rays excite the first and second phosphor layers 315 and 325, respectively, coated in the discharge cell 330. Accordingly, when the energy levels of the excited first and second phosphor layers 315 and 325, respectively, drop, visible light is emitted. The emitted visible light forms an image on the plasma display panel 300.

The characteristics of the plasma discharge are similar to those of the first embodiment, and thus their description will not be repeated.

In the plasma display panel according to the present invention, luminous efficiency is improved, the phosphor layer is protected from deterioration by ion sputtering, and the plasma display panel can be easily manufactured.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A plasma display panel, comprising:
a first substrate which includes first partition wall portions defining a plurality of discharge cells;
a second substrate which faces the first substrate, and which includes second partition wall portions defining the plurality of discharge cells together with the first partition wall portions;
a plurality of pairs of first and second discharge electrodes which generate discharge in the discharge cells;
a dielectric layer interposed between the first substrate and the second substrate;
phosphor layers located in the discharge cells; and
discharge gas located in the discharge cells.

2. The panel according to claim 1, wherein the first discharge electrodes are located in the first partition wall portions.

3. The panel according to claim 2, further comprising first protective layers located on at least a portion of the sides of the first partition wall portions in which the first discharge electrodes are located.

4. The panel according to claim 1, wherein the second discharge electrodes are located in the second partition wall portions.

5. The panel according to claim 4, further comprising second protective layers located on at least a portion of the sides of the second partition wall portions in which the second discharge electrodes are located.

6. The panel according to claim 1, wherein the first discharge electrodes surround the discharge cells arranged in a direction, and are connected to one another.

7. The panel according to claim 1, wherein the second discharge electrodes surround the discharge cells arranged in a direction, and are connected to one another.

8. The panel according to claim 1, wherein the dielectric layer is interposed between the first partition wall portions and the second partition wall portions.

9. The panel according to claim 1, wherein the first discharge electrodes and the second discharge electrodes extend so as to cross each other.

10. The panel according to claim 1, wherein the first discharge electrodes and the second discharge electrodes extend in parallel, and wherein the panel further comprises address electrodes which cross the first discharge electrodes and the second discharge electrodes.

11. The panel according to claim 10, further comprising a dielectric layer covering the address electrodes.

12. The panel according to claim 10, wherein the address electrodes are located on one of the first substrate and the second substrate.

13. The panel according to claim 1, wherein the phosphor layers are located on the first substrate facing the second substrate.

14. The panel according to claim 1, wherein the phosphor layers are located on the second substrate facing the first substrate.

15. The panel according to claim 1, wherein first grooves are formed in the first partition wall portions along the discharge cells arranged in a direction, and are connected to one another, and the first discharge electrodes are located in the first grooves;
wherein second grooves are formed in the second partition wall portions along the discharge cells arranged in a direction, and are connected to one another, and the second discharge electrodes are located in the second grooves; and
wherein the dielectric layer is interposed between the first discharge electrodes and the second discharge electrodes.

16. The panel according to claim 1, wherein the first substrate is made of a material containing glass.

17. The panel according to claim 1, wherein the second substrate is made of a material containing glass.

18. The panel according to claim 1, wherein the dielectric layer contains a light absorption material.

19. The panel according to claim 18, wherein the dielectric layer is colored.

20. The panel according to claim 18, wherein a light absorption ratio of the dielectric layer is in a range of 50% to 100%.
